(19) United States
(12) Patent Application Publication
(10) Pub. No.: US 2019/0342425 A1
(43) Pub. Date: Nov. 7, 2019

(54) METHOD AND SYSTEM FOR AUTONOMOUS CONTENT OPTIMIZATION IN GAMES AND GRAPHICAL INTERACTIVE APPLICATIONS

(71) Applicant: Unity IPR ApS, Copenhagen K (DK)

(72) Inventors: John Cheng, Lafayette, CA (US); Lauren Brooke Kearny, San Francisco, CA (US); Elie El Noune, San Francisco, CA (US); Angelo Ferro, San Francisco, CA (US); Yao Li, San Francisco, CA (US); Rolando Andrés Abarca Millán, San Francisco, CA (US)

(21) Appl. No.: 16/399,366

(22) Filed: Apr. 30, 2019

Related U.S. Application Data
(60) Provisional application No. 62/665,405, filed on May 1, 2018.
(60) Provisional application No. 62/665,407, filed on May 1, 2018.

(51) Int. Cl. H04L 29/06; G06T 19/00; H04L 29/08; G06N 20/00; H04L 12/24

(52) U.S. Cl. CPC H04L 67/38; G06T 19/003; H04L 67/34; H04L 41/509; H04L 41/083; H04L 41/0816; G06N 20/00

(57) ABSTRACT

There is described herein a system for autonomous content optimization for the adaptation of graphical interactive content on hardware and devices, utilizing behavioral and performance data across a network to optimize or improve quality and performance on the hardware and devices. In accordance with an embodiment, the ACO system can be configured to autonomously take content for a specific software application and make it perform optimally across a plurality of device types and operating systems and settings.

### CROSS REFERENCE TO RELATED APPLICATIONS

This application claims the benefit of U.S. Provisional Application No. 62/665,405, filed May 1, 2018, entitled “Method and system for creating adaptive onboarding experiences using machine learning,” and U.S. Provisional Application No. 62/665,407, filed May 1, 2018, entitled “Method and system for autonomous content optimization in games and graphical interactive applications,” each of which is incorporated by reference herein in its entirety.

### TECHNICAL FIELD

The present disclosure relates to the adaptation of graphical interactive content to improve or optimize device performance and user engagement for games and other interactive experiences.

### BACKGROUND OF THE INVENTION

Using graphical interactive content for a software application (e.g., for games, tutorials, virtual reality experiences, and the like) on a plurality of different device types and operating systems is challenging. One important challenge is mitigating performance issues that include application crashes, device crashes, overheating, and irregular frame rates which are mostly due to having graphical interactive content played on a wide range of device types and operating environments (including a variety of systems and system settings). The performance issues often occur because the graphical interactive content is not adapted to the specific capabilities of an individual device; for example, the content may be too complex or too high quality. The issues can result in a poor experience for a user and can ultimately lead to lower engagement and higher churn rate of users discontinuing their use of the application.

An existing solution, for a single application, involves manual testing of the application (e.g., which includes graphical interactive content) on a plurality of devices and operating systems before releasing the application to consumers. The manual testing solution is not scalable because of an incredibly large number of different device types that are available to users (e.g., more than 50,000 different types of devices use the Android operating system).

### BRIEF DESCRIPTION OF THE DRAWINGS

Further features and advantages of example embodiments of the present invention will become apparent from the following detailed description, taken in combination with the appended drawings, in which:

FIG. 1 is a schematic illustrating an autonomous content optimization system, in accordance with one embodiment;

FIG. 2 is a schematic illustrating a user device for an autonomous content optimization system, in accordance with one embodiment;

FIG. 3 is a schematic illustrating a server device for an autonomous content optimization system, in accordance with one embodiment;

FIG. 4 is a schematic illustrating a method for training a machine-learning (ML) system in an autonomous content optimization system, in accordance with one embodiment;

FIG. 5 is a method for optimizing the performance of an application on a specific device in an autonomous content optimization system, in accordance with one embodiment;

FIG. 6 is a schematic illustrating a table of quality settings for a profile in an autonomous content optimization system, in accordance with one embodiment;

FIG. 7 is a block diagram illustrating an example software architecture, which may be used in conjunction with various hardware architectures described herein; and

FIG. 8 is a block diagram illustrating components of a machine, according to some example embodiments, configured to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes example systems, methods, techniques, instruction sequences, and computing machine program products that constitute illustrative embodiments of the present subject matter, individually or in combination. In the following description, for the purposes of explanation, numerous specific details are set forth in order to provide an understanding of various embodiments of the present subject matter. It will be evident, however, to those skilled in the art, that various embodiments of the inventive subject matter may be practiced without these specific details.

What is described herein is a system for autonomous content optimization (ACO) for the adaptation of graphical interactive content on hardware and devices, utilizing behavioral and performance data across a network to optimize or improve quality and performance on the hardware and devices. In accordance with an embodiment, the ACO system can be configured to autonomously take content for a specific software application and make it scalable across a plurality of device types and operating systems and settings (e.g., cause the application to perform optimally or at least adequately across the plurality of devices). The ACO system can be configured to autonomously tune the complexity of graphical interactive content, after it has been released to consumers (e.g., post-launch), to deliver an improved or optimal experience (e.g., with good device performance) on a plurality of different device types and operating systems. The autonomous tuning is achieved with an ML system which is configured to optimize or improve performance of the application on a device and simultaneously optimize or improve user engagement with the application (e.g., to have users interact with the application for long periods of time, and use the application frequently, and the like). The ACO system described herein collects and analyzes a large data set (e.g., including user data from a plurality of users, device data from a plurality of user devices, and application data from a plurality of applications) using an ML reinforcement system to optimize the performance of the application running on a variety of device types and optimize the user engagement in an ongoing, real-time basis and with a changing environment (e.g., with available device types, networks and operating systems changing over time).

Throughout the description herein, the term ‘software application’ or simply ‘application’ is meant to include video games, tutorials, virtual reality applications, augmented reality applications, and the like. In addition, the term ‘graphical interactive content’ is meant to illustratively refer to interactive graphical elements included in an application, as well as associated settings that modify the elements, and unless noted otherwise, discussions herein regarding interactive graphical elements are applicable to non-interactive graphical elements. The elements include any virtual objects (e.g., 3D virtual objects) within an application, wherein the term virtual object includes video, lighting, characters, scene objects, background elements (e.g., terrain, sky, and the like), effects (e.g., sound and visual), and the like.

The terms ‘asset’, ‘game asset’, ‘virtual asset’, and ‘digital asset’, used herein are understood to include any data that can be used to define an element of graphical interactive content. For example, an asset can include data for an image, a 3D model (textures, rigging, and the like), an audio sound, a video, an animation, a 3D mesh and the like. The data describing an asset may be stored within a file, or may be contained within a collection of files, or may be compressed and stored in one file (e.g., a compressed file), or may be stored within a memory.

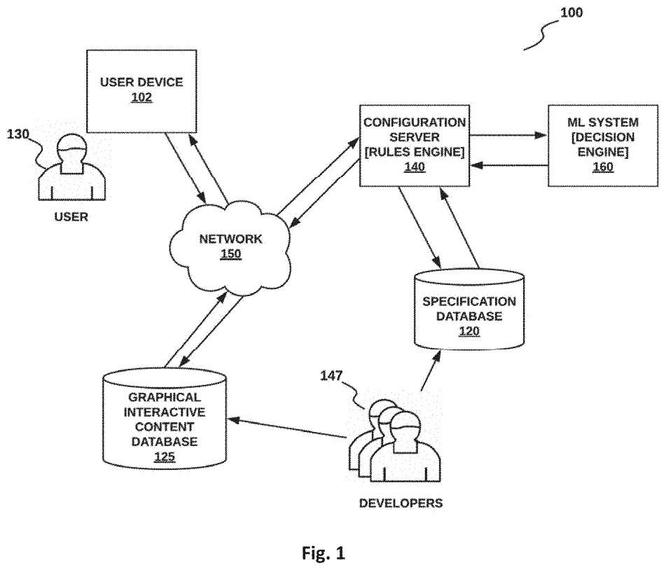

Turning now to the drawings, systems and methods for an autonomous content optimization system in accordance with embodiments of the present subject matter are illustrated. In accordance with an embodiment, FIG. 1 shows an ACO system 100 for adapting graphical interactive content for software applications using ML. In the example embodiment, the ACO system 100 includes a user device 102 operated by a user 130 (e.g., a game player, a student, a viewer, or the like), a configuration server 140, and a graphical interactive content database 125, all coupled in networked communication via a network 150 (e.g., a cellular network, a Wi-Fi network, the Internet, a wired local network, and the like). The ACO system 100 includes a machine learning (ML) system 160. In the example embodiment shown in FIG. 1, only one user device 102 is shown; however, any number of user devices 102 may be used. The user device 102 is a computing device capable of providing a multimedia experience (e.g., a video game, a simulation, a virtual reality experience, an augmented reality experience, and the like) to the user 130. In some embodiments, the user device 102 is a mobile computing device, such as a smartphone, tablet computer and head mounted display (HMD) such as virtual reality HMDs, augmented reality HMDs and mixed reality HMDs, and the like. In some embodiments, the user device 102 is a desktop computer or game console. The graphical interactive content database 125 includes graphical interactive content used by an application. In accordance with some embodiments, the ACO system 100 includes a specification database 120.

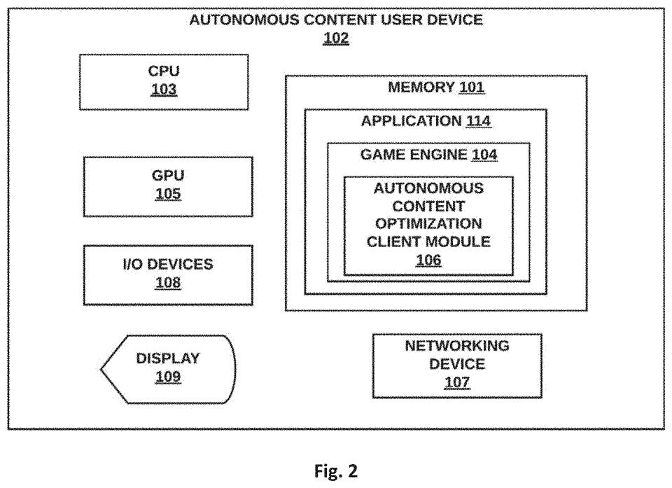

In accordance with an embodiment, FIG. 2 shows a user device 102 which includes one or more central processing units 103 (CPUs), and graphics processing units 105 (GPUs). The CPU 103 is any type of processor, processor assembly comprising multiple processing elements (not shown), having access to a memory 101 to retrieve instructions stored thereon, and execute such instructions. Upon execution of such instructions, the instructions implement the user device 102 to perform a series of tasks as described herein. The memory 101 can be any type of memory device, such as random access memory, read only or rewritable memory, internal processor caches, and the like.

The user device 102 also includes one or more input/output devices 108 such as, for example, a keyboard or keypad, mouse, pointing device, and touchscreen. The user device 102 further includes one or more display devices 109, such as a computer monitor, a touchscreen, and a head mounted display, which may be configured to display digital content including video, a video game environment and a virtual simulation environment to the user. The display device 109 is driven or controlled by the one or more GPUs 105 and optionally the CPU 103. The GPU 105 processes aspects of graphical output that assists in speeding up rendering of output through the display device 109. The user device 102 also includes one or more networking devices 107 (e.g., wired or wireless network adapters) for communicating across the network 150.

The memory 101 in the user device 102 can be configured to store an application 114 (e.g., executed by the CPU 103 or GPU 105) that communicates with the display device 109 and also with other hardware such as the input device(s) 108 to present an application (e.g., a video game, a simulation, an experience) to a user 130. In accordance with an embodiment, the application 114 may include a game engine. The game engine 104 would typically include a physics engine, collision detection, rendering, networking, sound, animation, and the like in order to provide the user with the application environment (e.g., video game environment). The application 114 includes an autonomous content optimization client module 106 (or simply ‘client module’ 106) that provides various ACO system functionality as described herein. Each of the client module 106, and the application 114 includes computer-executable instructions residing in the memory 101 that are executed by the CPU 103 and optionally with the GPU 105 during operation. The application 114 includes computer-executable instructions residing in the memory 101 that are executed by the CPU 103 and optionally with the GPU 105 during operation in order to create a runtime application program (e.g., which may include a runtime game engine). The client module 106 may be integrated directly within the application 114, or may be implemented as an external piece of software (e.g., a plugin).

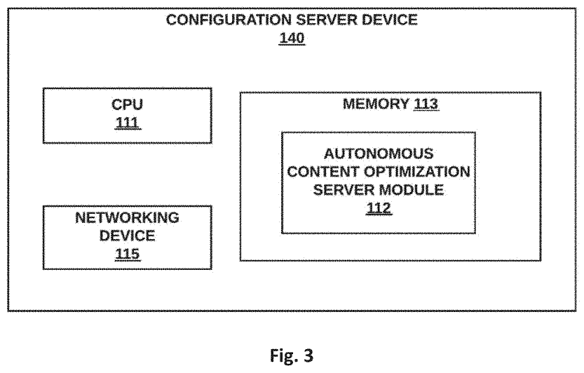

In accordance with an embodiment, FIG. 3 is a schematic diagram of a configuration server device 140 which includes a CPU 111 and a networking device 115 for communicating across the network 150 (e.g., with the user device 102). The configuration server 140 also includes a memory 113 for storing an autonomous content optimization server module 112 that provides various ACO system functionality as described herein. The server module 112 includes computer-executable instructions residing in the memory 113 that are executed by the CPU 111 during operation.

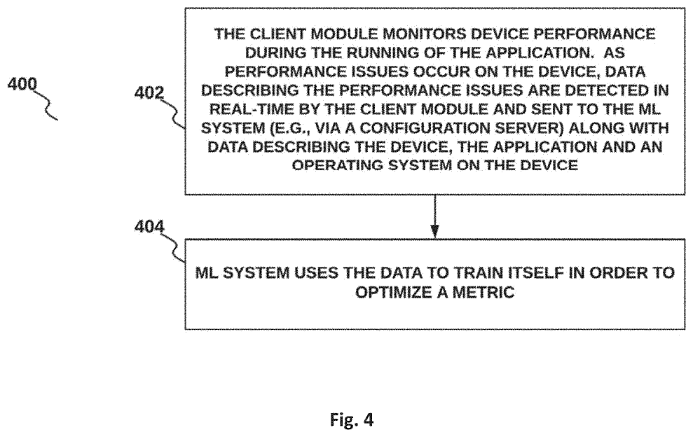

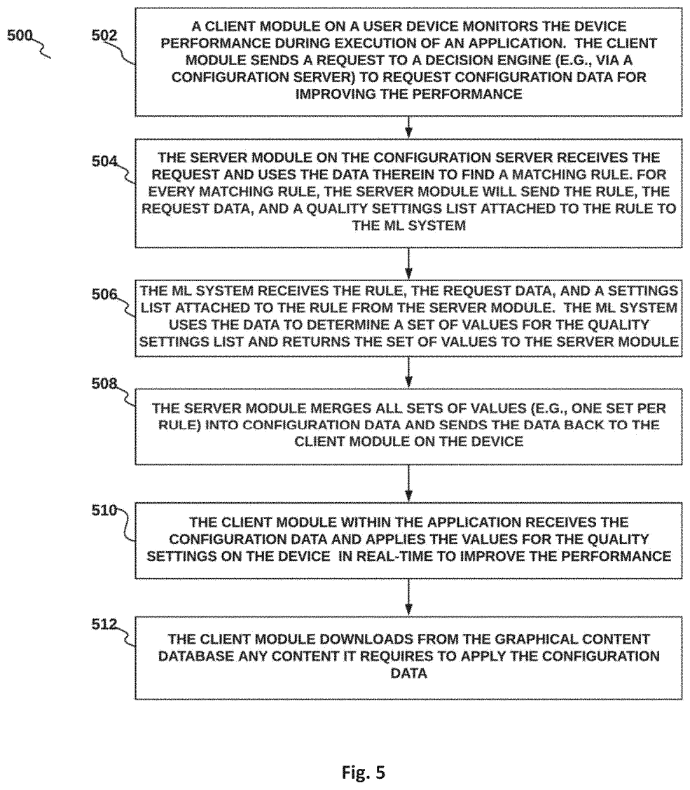

In accordance with an embodiment, the specification database 120 includes a device list, wherein the device list includes data describing the types of user devices that communicate (or have ever communicated) with the ACO system 100. The device list is updated (e.g., by the configuration server 140) as new devices communicate with the ACO system 100. Throughout the description herein, a type of user device should be understood to include a group of devices with similar specifications, including a manufacturer, a model, and an operating system version. The specification database 120 includes a plurality of definitions, and each definition includes one or more specifications which are included in a type of user device. The specification database 120 also includes performance data received from each user device 102 connected to the ACO system 100 (the process of the specification database 120 receiving the performance data from a user device 102 is described in detail below with respect to FIG. 4 and FIG. 5). Performance data received from a user device 102 describes the performance of the device 102 while executing functions of an application 114 (e.g., rendering, displaying, providing user interactivity, and the like). The performance data can include data typically associated with performance of a computational device that is executing an application 114; including displayed frame rate (e.g., high frame rate is associated with good performance), and number and frequency of application and device crashes (e.g., high crash rate is associated with poor performance), and application response time (e.g., response to user input), and the time to load and start the application, and the temperature of the CPU 103 while executing the application 114, and a percentage of memory 101 usage while executing the application 114, and the like. The performance data can also include application environment factors that include details of the operating system (and settings thereof) on the device 102 at the time of the execution of the application 114. For example, performance data received from a user device 102 indicating a low displayed frame rate can also include operating system settings (e.g., display settings, memory settings, and the like) in effect at the time of the low displayed frame rate. In accordance with an embodiment, on the specification database 120, the performance data describing a device is linked to the type of user device.

In accordance with an embodiment FIG. 4 shows a method 400 for training the ML system 160 to generate configuration data. The ML system 160 may be trained to improve or optimize one or more metrics. A metric is a measure of performance for the application 114 on the device 102, and examples of metrics include frame rate, application response time, and the like. One or more metrics may be chosen by a developer 147 of the game for improvement or optimization. The configuration data includes data describing settings used by the client module 106 to configure the application 114 on a device 102 during execution of the application 114. The configuration data includes a plurality of settings for each combination of application and type of device, which the ML system 160 has determined (e.g., via machine learning techniques as described with respect to FIG. 4 and FIG. 5) will provide improved or optimum performance (e.g., according to the metric) for the type of device and application combination. Configuration data includes settings (referred to herein as ‘quality settings’) determined by the ML system 160 for a single type of device combined with a single application (e.g., execution of that application by or on that type of device). The quality settings include data that specifies a quality of a virtual asset, one or more graphical settings and one or more rendering options. The quality of a virtual asset includes any value or setting of the virtual asset that can affect the rendered quality or performance of a virtual object which is rendered from the virtual asset by the application; including a polygon count in a 3D mesh for the virtual object, a number of joints in the virtual object, and the like. The graphical settings can include any value or setting used by the application that affects the graphical processing of virtual assets to display a scene in the application. For example, graphical settings can include settings that control the following: a quantity of virtual objects displayed simultaneously by the application in a scene (e.g., a number of non-player characters, or a number of background objects), a quantity, type, and properties of light sources used by the application in rendering a scene, a number of particles in a particle system used by the application when rendering a scene that includes particles (e.g., smoke), a method of handling reflections from surfaces within a scene, settings controlling the generation of procedural materials at runtime, and the like. The rendering options include any value or setting that affects the way in which the application renders virtual objects for display. Rendering options include values or settings for the following: a level-of-detail (LOD) for each virtual object, a type of occlusion used when rendering, properties of shadows used in rendering a scene, a method of handling reflections from surfaces within a scene, a shader program used during rendering, and the like.

In accordance with an embodiment, referring to FIG. 4, in operation 402 of the method 400, the client module 106 monitors performance of the user device 102 while the application 114 is running on the device 102. As one or more performance issues (e.g., a reduction in performance of the application executing on the device) occur on the device 102, they are detected in real-time by the client module 106 and data describing the performance issues is sent to the ML system 160. The data describing the performance issues (referred to herein as performance data) may be sent via the configuration server 140 and over the network 150. The device performance data can be sent at any time and with any frequency from a device 102 to the ML system 160. In addition to performance data, the client module 106 sends information describing the application 114 (or part thereof) as well as information describing the user device 102 (e.g., including the make and model of the device) as well as information on an operating system environment (e.g., an operating system version number and system settings). Furthermore, during operation, a plurality of user devices perform the operation 402 and send data to the ML system 160 over the network 150. When implemented, the ML system 160 can use data collected across billions of devices within an entire network of users (e.g., the network of users that create video games with the Unity™ game engine developed by Unity Technologies Inc.). In accordance with an embodiment, at operation 404 of the method 400, the ML system 160 is trained using the data collected during operation 402. For example, the ML system 160 can apply machine learning techniques (e.g., reinforcement learning) to the data in order to determine configuration data that can be applied on a user device 102 in order to improve performance (e.g., using the metric) for the user device 102 given all possible device type and application combinations. In accordance with an embodiment, and as part of operation 404, the ML system 160 may store performance data on a database (e.g., the specification database 120) and periodically extract the data for use in the training.

In accordance with an embodiment and shown in FIG. 5 is a method 500 for autonomous content optimization that can be implemented on the ACO system 100 shown in FIG. 1. At operation 502 of the method 500, the client module 106 within an application 114 on a user device 102, sends a request to a configuration server 140. For example, the request may be sent to improve performance or to reduce a drop in performance of the application executing on the device 102 and detected in real-time by the client module 106 (e.g., as seen in operation 402 of the method 400). The request is a query for configuration data which can be used by the device 102 to improve performance for a specific combination of the application 114 and the user device 102 on the specific user device making the request. The request might include a query for configuration data that describes a fraction of the application (e.g., such as a game level) rather than an entire application. The request includes information describing the application 114 (or part thereof) as well as information describing the user device 102 (e.g., including the make and model of the device) as well as information on the operating system environment (e.g., the operating system version number and system settings). At operation 504 of the method 500, the server module 112 within the configuration server 140 receives the request and uses the data therein to find a matching rule. A rule includes an expression (e.g., a Boolean expression) that determines a set of devices, a set of applications, a list of quality settings or a combination thereof. For example, a rule can determine a set of devices by operating system (type and version), by country, by manufacturer, by type of device and the like. As an example a rule may state the following: “10% of users in Canada should have the value ‘high’ for the setting ‘difficulty’”.

Referring back to FIG. 5, and in accordance with an embodiment, as part of operation 504, the server module 112 sends the rule, the request data and a quality settings list attached to the rule to the ML system 160. In accordance with an embodiment, at operation 506 of the method 500, the ML system 160 receives the rule, the request data and the quality settings list from the server module 112. The ML system uses the data to determine a set of values for the quality settings list and returns the set of values to the server module 112. The ML system determines the set of values which are optimal according to the training performed in operation 404 and which are specific for the requested application on the specific type of device that sent the request. In accordance with an embodiment, at operation 508 of the method 500, the server module 112 merges all sets of values (e.g., one set per rule) into configuration data and sends the data back to the client module 106 on the device 102. In accordance with an embodiment, as part of operation 508 of the method 500, the server module sends the determined configuration data (e.g., required for the specific application and specific device within the request) to the client module 106 on the user device 102 (e.g., the specific user device which sent the request). At operation 510 of the method 500, the client module 106 within the application 114 receives the determined configuration data and applies the determined values for the settings therein to the user device 102 and the application 114. As part of operation 510 of the method 500, the client module 106 on the device modifies values within the application 114 and within the operating system using the configuration data (e.g., modifying setting values) in real-time to improve the performance of the application 114 on the device 102. At operation 512 of the method 500, the client module 106 downloads content it requires (e.g., due to the settings in the determined configuration data) for the application 114 from the graphical interactive content database 125.

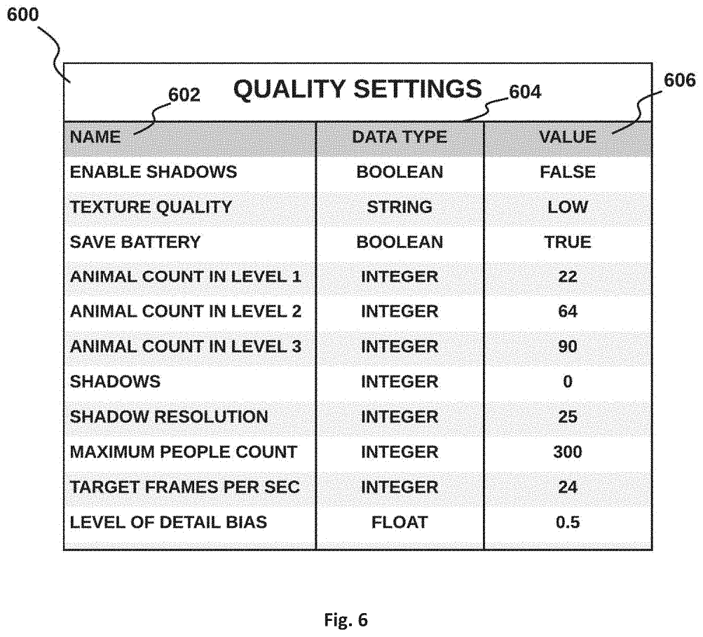

In accordance with an embodiment, FIG. 6 shows a table 600 of example quality settings list and values (e.g., for a specific combination of type of device and application). Each row in the table 600 represents a single setting for a particular aspect of quality (e.g., a rendering setting, a graphics setting, or an object quality setting). The table 600 includes three columns, with one column for the name of a setting 602, another column for the data type 604 (e.g., integer, Boolean, string, real number) of a setting, and one column for the default value 606 of the setting. The table 600 might be used by a developer of an application to set default values for each of the quality settings prior to the ML system 160 adjusting the values in operation 506 of the method 500. The table 600 might also be used by a developer to set limiting values (e.g., maximum and minimum values) for the quality settings (limiting values not shown in FIG. 6). The limiting values for each setting would be used as constraints by the ML system 160 in operation 506 of the method 500. Although shown as a table in FIG. 6, any other format can be used for the quality settings.

While illustrated in the block diagrams as groups of discrete components communicating with each other via distinct data signal connections, it will be understood by those skilled in the art that various embodiments are implemented by a combination of hardware and software components, with some components being implemented by a given function or operation of a hardware or software system, and many of the data paths illustrated being implemented by data communication within a computer application or operating system. The structure illustrated is thus provided for efficiency and clarity.

It should be noted that the present disclosure can be carried out as a method, can be embodied in a system, a computer readable medium or an electrical or electro-magnetic signal. The embodiments described above and illustrated in the accompanying drawings are intended to be examples only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

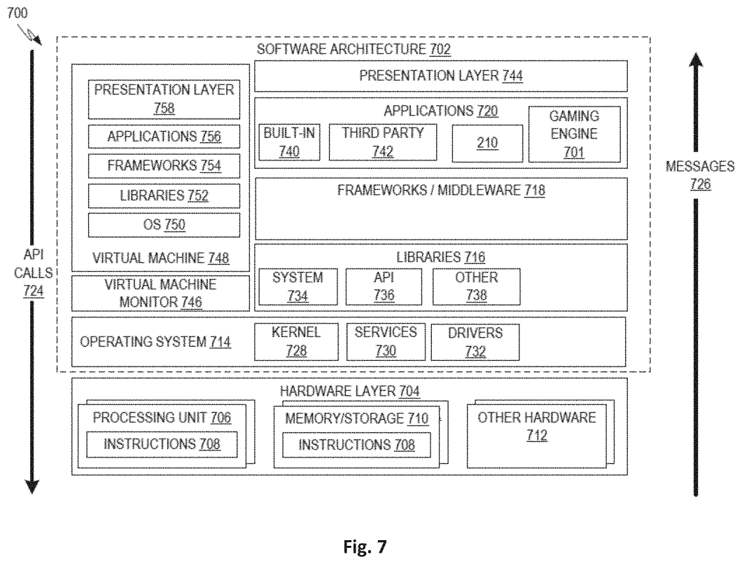

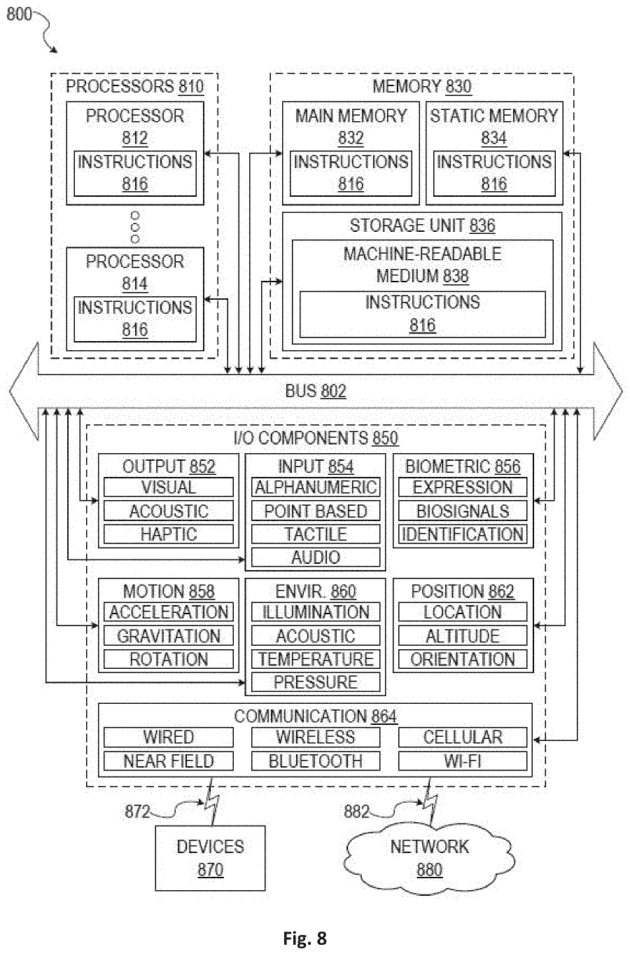

FIG. 7 is a block diagram 700 illustrating an example software architecture 702, which may be used in conjunction with various hardware architectures herein described to provide a gaming engine 701 and/or components of the autonomous content optimization system 100. FIG. 7 is a non-limiting example of a software architecture and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 having associated executable instructions 708. The executable instructions 708 represent the executable instructions of the software architecture 702, including implementation of the methods, modules and so forth described herein. The hardware layer 704 also includes memory/storage 710, which also includes the executable instructions 708. The hardware layer 704 may also comprise other hardware 712.

In the example architecture of FIG. 7, the software architecture 702 may be conceptualized as a stack of layers where each layer provides particular functionality. For example, the software architecture 702 may include layers such as an operating system 714, libraries 716, frameworks or middleware 718, applications 720 and a presentation layer 744. Operationally, the applications 720 and/or other components within the layers may invoke application programming interface (API) calls 724 through the software stack and receive a response as messages 726. The layers illustrated are representative in nature and not all software architectures have all layers. For example, some mobile or special purpose operating systems may not provide the frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth, drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 816 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) provide a higher-level common infrastructure that may be used by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 742 may invoke the API calls 724 provided by the mobile operating system such as operating system 714 to facilitate functionality described herein.

The applications 720 may use built-in operating system functions (e.g., kernel 728, services 730 and/or drivers 732), libraries 716, or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures use virtual machines. In the example of FIG. 7, this is illustrated by a virtual machine 748. The virtual machine 748 creates a software environment where applications/modules can execute as if they were executing on a hardware machine (such as the machine 800 of FIG. 8, for example). The virtual machine 748 is hosted by a host operating system (e.g., operating system 714) and typically, although not always, has a virtual machine monitor 746, which manages the operation of the virtual machine 748 as well as the interface with the host operating system (i.e., operating system 714). A software architecture executes within the virtual machine 748 such as an operating system (OS) 750, libraries 752, frameworks 754, applications 756, and/or a presentation layer 758. These layers of software architecture executing within the virtual machine 748 can be the same as corresponding layers previously described or may be different.

FIG. 8 is a block diagram illustrating components of a machine 800, according to some example embodiments, configured to read instructions from a machine-readable medium (e.g., a machine-readable storage medium) and perform any one or more of the methodologies discussed herein. In some embodiments, the machine 110 is similar to the HMD 102. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory 830, and input/output (I/O) components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core processor), multiple processors with a single core, multiple processors with multiples cores, or any combination thereof.

The memory/storage 830 may include a memory, such as a main memory 832, a static memory 834, or other memory, and a storage unit 836, both accessible to the processors 810 such as via the bus 802. The storage unit 836 and memory 832, 834 store the instructions 816 embodying any one or more of the methodologies or functions described herein. The instructions 816 may also reside, completely or partially, within the memory 832, 834, within the storage unit 836, within at least one of the processors 810 (e.g., within the processor's cache memory), or any suitable combination thereof, during execution thereof by the machine 800. Accordingly, the memory 832, 834, the storage unit 836, and the memory of processors 810 are examples of machine-readable media 838.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific input/output (I/O) components 850 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 850 may include many other components that are not shown in FIG. 8. The input/output (I/O) components 850 are grouped according to functionality merely for simplifying the following discussion and the grouping is in no way limiting. In various example embodiments, the input/output (I/O) components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 862, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

1) A system comprising: a user device communicatively coupled to a configuration server and a database, wherein the user device is configured to perform the following operations:
executing an application;
executing a client module to monitor performance of the user device while executing the application;
based on the client module detecting a reduction in the performance, sending a request over a network to the configuration server, the request requesting configuration data for the user device and the application;
based on the client module receiving the configuration data over the network, modifying properties within the application based on the configuration data to counteract the reduction in the performance; and
downloading virtual asset content from the database in real-time based on the configuration data to counteract the reduction in the performance.

2) The system of claim 1, the operations further comprising:
recording data that describes the application, the device, and the reduction in the performance, and sending the data over a network to the database.

3) The system of claim 2, wherein the configuration data is generated by a machine-learned model configured to determine parameters for the application to counteract the reduction, and configured to determine virtual asset content for the application to counteract the reduction.

4) The system of claim 1, wherein the request includes application data specifying the state of the application and device data specifying an identifier of the device and a state of the device.

5) The system of claim 1, wherein the modifying of the properties includes at least one of: specifying the quality of virtual asset content to be used in the application, modifying graphical settings, or modifying rendering options within the application.

6) A method comprising:
by a user device communicatively coupled to a configuration server and a database:
executing an application;
executing a client module to monitor performance of the user device while executing the application;
based on the client module detecting a reduction in the performance, sending a request over a network to the configuration server, the request requesting configuration data for the user device and the application;
based on the client module receiving the configuration data over the network, modifying properties within the application based on the configuration data to counteract the reduction in the performance; and
downloading virtual asset content from the database in real-time based on the configuration data to counteract the reduction in the performance.

7) The method of claim 6, the operations further comprising:
recording data that describes the application, the device, and the reduction in the performance, and sending the data over a network to the database.

8) The method of claim 7, wherein the configuration data is generated by a machine-learned model configured to determine parameters for the application to counteract the reduction, and configured to determine virtual asset content for the application to counteract the reduction.

9) The method of claim 6, wherein the request includes application data specifying the state of the application and device data specifying an identifier of the device and a state of the device.

10) The method of claim 6, wherein the modifying of the properties includes at least one of: specifying the quality of virtual asset content to be used in the application, modifying graphical settings, or modifying rendering options within the application.

11) A non-transitory machine-readable storage medium comprising instructions that, when executed by one or more processors of a machine communicatively coupled to a configuration server and a database, cause the machine to perform operations comprising:
executing an application;
executing a client module to monitor performance of the machine while executing the application;
based on the client module detecting a reduction in the performance, sending a request over a network to the configuration server, the request requesting configuration data for the machine and the application;
based on the client module receiving the configuration data over the network, modifying properties within the application based on the configuration data to counteract the reduction in the performance; and
downloading virtual asset content from the database in real-time based on the configuration data to counteract the reduction in the performance.

12) The non-transitory machine-readable storage medium of claim 11, the operations further comprising:
recording data that describes the application, the device, and the reduction in the performance, and sending the data over a network to the database.

13) The non-transitory machine-readable storage medium of claim 12, wherein the configuration data is generated by a machine-learned model configured to determine parameters for the application to counteract the reduction, and configured to determine virtual asset content for the application to counteract the reduction.

14) The non-transitory machine-readable storage medium of claim 11, wherein the request includes application data specifying the state of the application and device data specifying an identifier of the device and a state of the device.

15) The non-transitory machine-readable storage medium of claim 11, wherein the modifying of the properties includes at least one of: specifying the quality of virtual asset content to be used in the application, modifying graphical settings, or modifying rendering options within the application.
